(19) United States
(12) Patent Application Publication
(10) Pub. No.: US 2007/0153297 A1
(43) Pub. Date: Jul. 5, 2007

(54) Photogrammetric Targets

(76) Inventor: Kam C. Lau, Potomac, MD (US)

Correspondence Address: BRUCE E. WEIR, 12 SPARROW VALLEY COURT, MONTGOMERY VILLAGE, MD, 20886-1265, US

(21) Appl. No.: 11/649,657

(22) Filed: Jan. 4, 2007

Related U.S. Application Data
(60) Provisional application No. 60/756,273, filed on Jan. 4, 2006.

(51) Int. Cl. G01B 11/14

(52) U.S. Cl. 356/620

(57) ABSTRACT

A photogrammetric target has a corner cube retroreflector centered within one reflective surface or between two or more reflective surfaces. A single reflective surface may be an annular disk. Alternatively, several small reflectors may be symmetrically arrayed on a lower-reflectivity surface, with a corner cube retroreflector substantially centered within the array. When such targets are mounted on a structure subject to photogrammetric measurement, the corner cube retroreflectors may be quickly and accurately located with a laser tracker or a laser surveying device, improving the accuracy of photogrammetric analysis. Since photogrammetric analysis software may locate the centroid of an image of a symmetrical array of small reflectors more accurately than the centroid of the image of a disk or other single reflective object, use of a reflector array may improve measurement accuracy.

### CROSS-REFERENCE TO RELATED APPLICATION

This application claims priority from provisional patent application Ser. No. 60/756,273, filed Jan. 4, 2006 by the same inventor, now pending.

### BACKGROUND

Photogrammetric analysis can provide a quick and relatively accurate tool for measuring the dimensions of structures or geographic features that may be too large, too dangerous, too delicate, too complex, or too difficult to reach to be cost-effectively measured with conventional tools. Since photographs usually do not include scale indicators, control points of known location and/or separation must be included in each image to provide scale and, when a structure or feature is too large for a single photograph, to provide reference points to allow accurate registration of points in overlapping images. Accurate control point location is especially important in stereoscopic image analysis methods commonly used to reveal dimensional features of a photographic subject.

Photogrammetric targets often serve as reference points. Such targets are frequently small disks with crosshairs printed on a reflective side and adhesive applied to the opposite side. The adhesive side of a disk is applied to each point to be measured on a structure or feature and the locations of and/or separation between at least two control points are measured. Measurements may be made manually or with a laser surveying device such as a total station. A series of overlapping photographs are taken for later analysis.

Adhesive-backed targets with crosshairs impose some limitations on the accuracy of positional measurements. Targets may be difficult to apply to painted, corroded, or contaminated surfaces. Surfaces to be measured may be shaped or oriented in a manner that diminishes the intensity of light reflected from a target to a surveying device or camera. Operators may incorrectly align a survey device upon crosshairs. Reflections diffused by a non-specular target reduce the accuracy of a laser ranging device.

### SUMMARY

The limitations of existing photogrammetric targets may be mitigated by combining a corner cube retroreflector with a photogrammetric reflector, allowing an operator to use a laser surveying device or a laser tracker to measure the position of the corner cube retroreflector with increased accuracy while acquiring the more photographically-visible image of the photogrammetric reflector for image analysis. One embodiment of the invention places a corner cube retroreflector in the center of a circular photogrammetric reflector, with both reflectors mounted on a base that is attached to a structure. The reflectors may be reoriented to compensate for the shape or orientation of a measured surface. In a preferred embodiment, the photogrammetric target comprises a group of reflective spots symmetrically disposed around the corner cube retroreflector, thereby improving the ability of photogrammetric image analysis software to locate the center of the photogrammetric target.

### BRIEF DESCRIPTION OF THE DRAWINGS

FIG. 1 shows a top plan view of a photogrammetric target.

FIG. 2 shows a cross-sectional side elevation view of the photogrammetric target of FIG. 1 with a tilted retroreflector.

FIG. 3 shows a schematic view of the photogrammetric target of FIG. 1 in use.

FIG. 4 shows a schematic diagram of photogrammetric target of FIG. 3 used to assist photogrammetric analysis of a large structure.

FIG. 5 shows a top plan view of a portion of a photogrammetric target with eight discrete, symmetrically-arrayed photogrammetric reflectors.

FIG. 6 shows a cross-sectional side elevation view of an embodiment of the photogrammetric target of FIG. 5 with an optional pin hole.

### DESCRIPTION

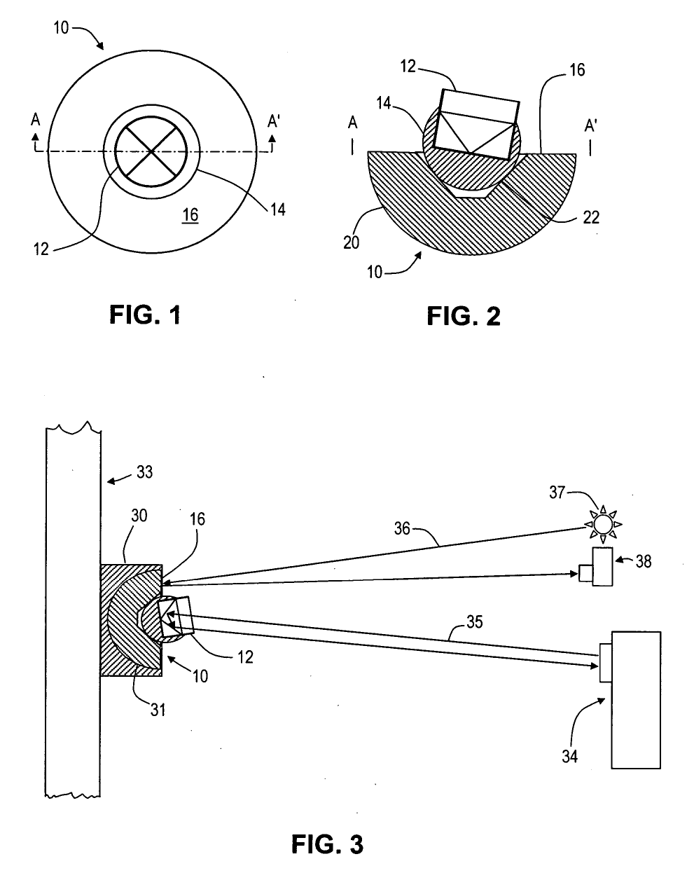

A first embodiment of the invention combines a corner cube retroreflector with a photogrammetric reflector to allow rapid, precise measurement of photogrammetric target position with a laser tracker or a laser surveying device such as a total station. As shown in FIG. 1, this embodiment of the target 10 includes a corner cube retroreflector 12 as is known in the art partially inserted into a sphere 14 and retained by magnetic attraction or by a friction fit. The corner cube retroreflector 12 is surrounded by a photogrammetric reflector 16. The exposed surface of the photogrammetric reflector 16 may be any high-contrast reflective material, but materials such as 3M™ 7610 High Gain Reflective Sheeting made by Minnesota Mining and Manufacturing of St. Paul, Minn. are preferred for their ability to return a high percentage of incident light.

FIG. 2 shows a cross-sectional side elevation view of the target 10 of FIG. 1 with the retroreflector angled with respect to the photogrammetric reflector 16. The photogrammetric reflector 16 is mounted on the flat disk surface of a body 20 with a retroreflector receiving cavity 22 shaped to receive and securely hold the sphere 14. The corner cube retroreflector 12, sphere 14, and body 20 share a common center.

FIG. 3 shows a schematic view of an embodiment of the invention in use. The target 10 is inserted within a target receiving cavity 31 in a mount 30, which is in turn attached to a structure 33 being measured. The target 10 and mount 30 are both shown in cross-section for clarity. A laser beam 35 emitted by a laser tracker or a laser surveying device 34 as known in the art impinges upon the corner cube retroreflector 12 and is returned to the device 34 for measurement, calculation, and storage of the target 10 position. A similar positional measurement made of another corner cube retroreflector in another target allows a precise calculation of the distance between corner cube retroreflectors in each target, providing a precise scale for photogrammetric analysis of an image including both targets. Since a laser tracker or laser surveying device 34 measures the distance between the device 34 and a target 10 as well as angular displacement between targets, each target 10 can also be located in three dimensions.

Light 36 from a light source 37 is reflected by the photogrammetric reflector 16 to a camera 38 or other photogrammetric imaging device such as the INCA3™ camera produced by Geodetic Systems, Inc. of Melbourne, Fla. Images recorded by the imaging device may be printed and analyzed manually by methods well-known in the art using target position measurements output from the laser tracker or laser surveying device 34. However, digital image data from the camera 38 and target 10 location data from a laser tracker or laser surveying device 34 may also be analyzed in real time by photogrammetric analysis software supplied with known systems such as the VSTARS system produced by Geodetic Systems, Inc.

The relative positions of the target 10, laser tracker or laser surveying device 34, light source 37, and imaging device 38 as shown in FIG. 3 are chosen merely for ease of illustration. In actual use these components may be widely separated according to the requirements of each application. The camera 38 resolves the image of the photogrammetric reflector 16 most accurately when the photogrammetric reflector 16 is nearly orthogonal to the axis of the camera lens. Accordingly, the target 10 may be rotated within the target receiving cavity 31 to adjust the angle of the photogrammetric reflector 16. The corner cube retroreflector 12 has an angle of acceptance of ±35 degrees and may be rotated within the body 20±45 degrees, allowing the corner cube retroreflector 12 to return a laser beam 35 at an angle of 10 or more degrees with respect to the surface of the photogrammetric reflector 16. Since the corner cube retroreflector 12, sphere 14, and body 20 share a common center, the center of the photogrammetric reflector 16 may be measured accurately with a laser tracker or a laser surveying device 34 regardless of the orientations of the components.

Although the sphere 14, the body 20, and the reflector receiving cavity 31 of this embodiment are all depicted as utilizing spherical sections to facilitate easy assembly and angular adjustment of the corner cube retroreflector 12 and photogrammetric reflector 16, other shapes known in the art may be utilized for specific applications. A magnetic mount 30 is especially useful for rapid and secure attachment to a steel structure 33. Additionally, when the target 10 is made of ferrous metal, a magnetic mount serves to hold the target 10 in the reflector receiving cavity 31.

Alternatively, an adhesive or a suction device may be used to attach the mount 30 to a non-ferrous structure 33. The target 10 and mount 30 may also be made of plastics, ceramics, or other materials known in the art. Regardless of composition, the mount 30 may have a circular cross-section or any other shape and dimensions deemed optimal for a specific application, or may have articulated sections to provide greater angular adjustment range.

Several features common to most embodiments of the invention may contribute to improved accuracy in photogrammetric measurements, making these embodiments especially useful for locating control points. The target 10 may be of any desired size. Increased photogrammetric reflector 16 area may be favored in applications where the subject is strongly lit by a source substantially removed from the camera 38, causing the protruding corner cube retroreflector 12 to cast a shadow upon a portion of the photogrammetric reflector 16. Since photogrammetric image processing software often locates the center of a target by finding the centroid of a high-contrast spot on a photograph, larger photogrammetric reflector 16 area can minimize error by reducing the proportion of a photogrammetric reflector 16 covered by a shadow.

The corner cube retroreflector 12 and the photogrammetric reflector 16 may be rotated within the mount 30 through a range of angles, so that each reflector is more nearly orthogonal to incident light and better able to return a reflection. Reflection by the corner cube retroreflector 12 of a laser beam from an interferometric laser tracker can reduce measurement error to approximately 5 ppm, compared to a typical total station measurement error of approximately 20 ppm. Additionally, the speed and ease with which embodiments of the invention may be positioned and measurements made allow images to be acquired within a short span of time, minimizing changes in measured surfaces or structures resulting from environmental factors such as temperature and vibration.

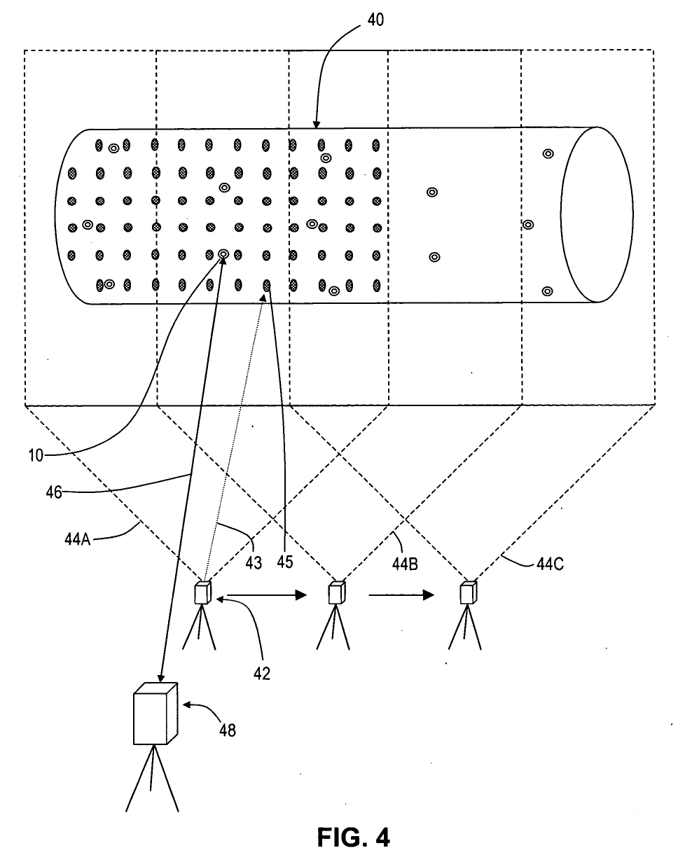

FIG. 4 shows a schematic diagram of an embodiment of the invention used to assist photogrammetric analysis of a large structure. Targets 10 on mounts (not visible) are attached to key points on a structure 40. A laser tracker or laser surveying device 48 emits a laser beam 46 that reflects from a target 10 back to the laser tracker or laser surveying device 48, which then calculates and stores the position of the target 10. Several other targets 10 on the structure 40 are similarly located. To better reveal the surface contour of the structure 40 and provide more data points for photogrammetric analysis, additional reflectors 45 may be applied over the surface of the structure 40. Alternatively or additionally, a grid of light spots 45 may be projected 43 onto the surface of the structure 40 by a projection device such as a PRO-SPOT™ target projector from Geodetic Systems, Inc. of Melbourne, Fla. operating in conjunction with a photogrammetry device 42.

The photogrammetry device 42, which includes the camera 38, and, optionally, light source 37 of FIG. 3, acquires an image within the field of view 44A that includes a portion of the structure 40 and several targets. The photogrammetry device 42 is then repositioned at intervals to acquire targets and images within fields of view 44B, 44C that substantially overlap adjacent fields of view, thereby imaging a structure 40 that is too large to be encompassed within a single field of view. In addition to providing scale, located targets appearing in two or more overlapping images allow precise registration of the images to facilitate stereoscopic image analysis. Since rotation of a target 10 within a target receiving cavity 31 does not change the location of the target's center, the angles of the photogrammetric reflectors 16 may be readjusted each time the photogrammetry device 42 is repositioned to present more easily-resolved images to the photogrammetry device 42.

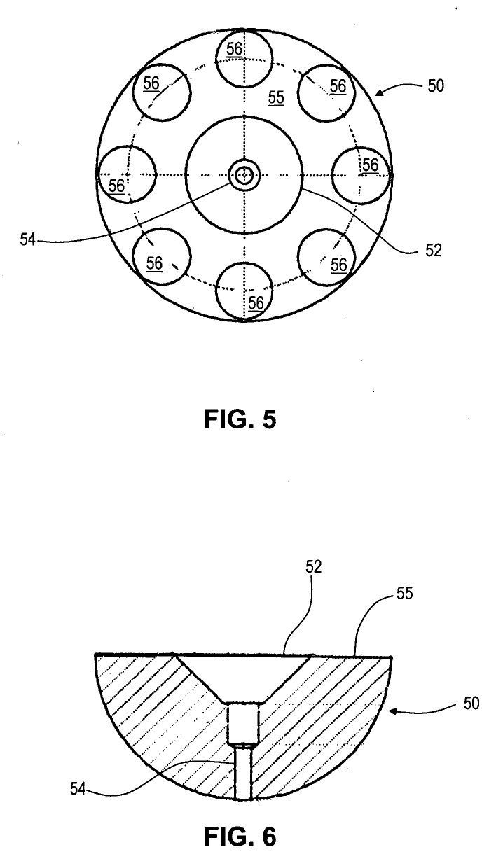

FIG. 5 shows a portion of a preferred embodiment of a photogrammetric target 50. The flat disk surface 55 shown in FIG. 5 is of low to moderate reflectivity. High-reflectivity photogrammetric reflectors 56 are distributed symmetrically around the center of the flat disk surface 55. The photogrammetric reflectors 56 may be any high-contrast reflective material, but materials such as 3M™ 7610 High Gain Reflective Sheeting as previously described are preferred. A low-reflectivity flat disk surface 55 is preferred to improve contrast. FIG. 5 shows eight photogrammetric reflectors disposed upon the flat disk surface 55. A least four photogrammetric reflectors are preferred, but any suitable number may be utilized, preferably although not necessarily disposed in symmetrical patterns.

The embodiment of FIG. 5 is advantageous because each photogrammetric reflector 56 may be individually resolved by a camera, allowing calculation of a centroid between arrayed photogrammetric reflectors 56. Finding the centroid of such an array may allow more accurate location of the center of the flat disk surface 55 and the center of a corner cube retroreflector mounted thererin (not shown) than may be obtained for the centroid of a single annular disk. Although photogrammetric reflectors 56 of many shapes and sizes can be utilized, circles of equal area positioned at a constant radius from the center of the flat disk surface 55 are preferred for ease of resolution and calculation. Additionally, one or more photogrammetric reflectors 56 may be removed or obscured in coded patterns to identify specific targets. As many as three photogrammetric reflectors 56 may be removed or obscured in this embodiment without significantly affecting measurement accuracy, preferably although not necessarily in symmetrical patterns.

Although the photogrammetric reflector 55 of FIG. 5 may be utilized without a corner cube retroreflector, a retroreflector may be mounted in the center of the flat disk surface 55 in the same manner and for the same purposes as described for the embodiment of FIG. 1. FIG. 6 shows a cross-sectional side elevation view of an embodiment of the photogrammetric reflector of FIG. 5 having an optional pin hole 54 drilled from its apex. The optional pin hole 54 allows insertion of a wire or thin rod to eject the retroreflector (not shown) from the body 50. The 120 degree chamfer around the sides of the retroreflector receiving cavity 52 allows a user to easily adjust and remove a sphere and corner cube reflector (not shown).

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

I claim:

1. A photogrammetric target, comprising:
a photogrammetric reflector, and
a corner cube retroreflector, the corner cube retroreflector substantially centered within the photogrammetric reflector.

2. A photogrammetric target as claimed in claim 1, wherein the photogrammetric reflector is disposed upon at least a portion of a body, the body being retained by a mount.

3. A photogrammetric target as claimed in claim 2, wherein the mount is magnetic.

4. A photogrammetric target as claimed in claim 2, wherein the mount comprises articulated sections.

5. A photogrammetric target, comprising:
a body, the body having at least a first surface; and
at least two photogrammetric reflectors disposed upon the first surface, the photogrammetric reflectors having greater reflectivity than the first surface.

6. A photogrammetric target as claimed in claim 5, wherein the body is retained by a mount.

7. A photogrammetric target as claimed in claim 6, wherein the mount is magnetic.

8. A photogrammetric target as claimed in claim 6, wherein the mount comprises articulated sections.

9. A photogrammetric target as claimed in claim 5, wherein the photogrammetric reflectors are symmetrically arrayed.

10. A photogrammetric target, comprising:
a body, the body having at least a first surface;
at least two photogrammetric reflectors symmetrically disposed upon the first surface, the photogrammetric reflectors having greater reflectivity than the first surface; and
a corner cube retroreflector, the corner cube retroreflector substantially centered between the photogrammetric reflectors.

11. A photogrammetric target as claimed in claim 10, wherein the body is retained by a mount.

12. A photogrammetric target as claimed in claim 11, wherein the mount is magnetic.

13. A photogrammetric target as claimed in claim 11, wherein the mount comprises articulated sections.

14. A system for photogrammetric measurement of a structure, comprising:
at least a first photogrammetric target and a second photogrammetric target, each photogrammetric target comprising a photogrammetric reflector and a corner cube retroreflector, the corner cube retroreflector substantially centered within the photogrammetric reflector;
a photogrammetric target location device utilizing a laser to locate photogrammetric targets; and
a photogrammetric imaging device.

15. A system for photogrammetric measurement of a structure as claimed in claim 14, wherein the photogrammetric target location device is a laser tracker.

16. A system for photogrammetric measurement of a structure as claimed in claim 14, wherein the photogrammetric target location device is a total station.

17. A method for photogrammetric measurement of a structure, comprising:
mounting a first corner cube reflector within photogrammetrically reflective portions of a first surface;
mounting a second corner cube reflector within photogrammetrically reflective portions of a second surface;
mounting the each combined corner cube reflector and surface on a first structure;
locating the center of each corner cube reflector with a photogrammetric target location device;
recording the location of the center of each corner cube reflector;
measuring the distance between the center of the first corner cube reflector and the center of the second corner cube reflector;
acquiring an image of the structure;
locating the image of the first surface and the image of the second surface within the image of the structure;
finding the centroid of the image of the first surface and the centroid of the image of the second surface;
measuring the distance between the centroid of the image of the first surface and the centroid of the image of the second surface within the image of the structure; and
utilizing the measured distance between the center of the first corner cube reflector and the center of the second corner cube reflector and the measured distance between the centroid of the image of the first surface and the centroid of the image of the second surface to calculate a scale factor for the image of the structure.
